(19) United States
(12) Patent Application Publication
(10) Pub. No.: US 2026/0226790 A1
(43) Pub. Date: Aug. 6, 2026

(54) Finger Guard Assembly

(71) Applicant: Darren THOMPSON, London (GB)

(72) Inventor: Darren THOMPSON, London (GB)

(21) Appl. No.: 19/149,479

(22) PCT Filed: Jan. 25, 2024
(86) PCT No.: PCT/GB2024/050195

§ 371 Date: Jul. 18, 2025

(30) Foreign Application Priority Data
Jan. 27, 2023 (GB) 2301182.8

(51) Int. Cl. E06B 7/36

(52) U.S. Cl. CPC E06B 7/36

(57) ABSTRACT

finger guard assembly for a door. The assembly comprises a first strip having means to attach the strip along at least part of the length of the door frame, a second strip section connectable and along at least part of one edge of the first strip one side of the door frame; and a third strip connectable to and along at least part of an opposing of the first strip on the other side of the door frame.

### FIELD ON THE INVENTION

This invention relates to a finger guard assembly and, more especially, this invention relates to a portable finger guard assembly for a door. More especially, this invention relates to a finger guard assembly that does not require any securement to any front facing part of the door.

### BACKGROUND TO THE INVENTION

Finger guards have become increasingly popular over recent years due to the number of door-related accidents, mainly to children, and following a report released by the British Association of Plastic and Reconstructive Surgeons (BAPRAS) urging parents and carers to consider the routine use of door stops and hinge guards to reduce the number of incidents of hand and finger crushing caused by the closing of doors, estimated to be approximately 50,000 children each year.

Despite such incidents, finger guards are not routinely provided or available in the ranges of baby and child safety products of major retailers.

Finger guards are available which are secured to the door surface. Whilst they provide protection, they are only really required for a fairly short period of time in the lives of a family, during the time when the children are not old enough to understand the need for caution and to not be aware of the risks to their finger when doors are closed.

Once the children are older, there is no longer a need for finger guards, and, in many cases, permanent or semi-permanent finger guards would be undesirable due to the obtrusive design required to cover the entire length of the door.

Removal of finger guards that have been secured to the door, often leaves unsightly marks or even damage to the door surface, at areas where the finger guard was secured.

The present invention seeks to provide a finger guard assembly which can be assembled and disassembled efficiently and easily without affecting any part of the door surface or outer door frame.

Further, the invention seeks to provide a finger guard assembly of simple construction, that can be assembled and installed without any required expertise or the need for any special tooling. It is intended that the finger guard assembly is provided to the consumer in a kit of parts for assembly at home. The assembly is made from simple materials to be affordable so that a consumer can acquire a number of packs, depending on the number of doors they have.

The parts of each assembly are constructed and designed to be applicable to any door design, irrespective, for example, of the number or location of door hinges.

The finger guard assembly is designed to provide lengthwise protection along the open and closed hinge section of the door and to be secured to and through the inner frame of the door, rather than the door itself. This ensures that the finger assembly can be disassembled and removed when no longer required with no damage to the door.

### STATEMENTS OF THE INVENTION

According to one aspect of the invention, there is provided a finger guard assembly for a door hingedly attached to a door frame, the assembly comprising: a first strip having means to attach the strip along at least part of the length of the door frame, a second strip section connectable to and along at least part of one edge of the first strip one side of the door frame; and a third strip connectable to and along at least part of an opposing of the first strip on the other side of the door frame.

Preferably, second and third strips provide a physical barrier along each side of the door frame to prevent insertion of a user's fingers in to door frame.

Preferably, at least one strip is made from a thermoplastic polymer material.

Preferably, the first strip has a substantially L-shaped profile.

Preferably, one arm of the first strip is attached to a sidewall of a door stop of the door frame, in use.

Preferably, the arm is attached using self-adhesive tape.

Preferably, a second arm of the first strip is attached to a door jam of the door frame, in use. Preferably, the second arm is attached using self-adhesive tape.

Preferably, an end longitudinal edge of the second arm is formed with a plurality of dovetail recesses.

Preferably, when the first strip is attached to the door frame, finger extensions formed by the recesses extend through the door hinges.

Preferably, the assembly further comprises at least two connecting members, each having a complimentary dovetail shaped profile at one end to be received, in use to respective recesses of the first strip.

Preferably, the third strip is attached to each at least connecting members to extend therebetween.

Preferably, the second strip comprises a plurality of sections divided by flexible hinges.

Preferably, one section of the second strip is attachable in use, to the first strip.

Preferably, an end section of the second strip is attachable to an end surface of the door, in use. Preferably, the third strip is comprises a plurality of sections divided by flexible hinges.

Preferably, the flexible hinges are constructed to flex in only one direction.

According to a second aspect of the invention, there is provided method of installing a finger guard assembly within a door assembly, the door assembly comprising a door hingedly attached to a door frame, the finger assembly comprising first second and third strip members and at least two connecting members, the method comprising the steps of: attaching he first strip member to and along at least part of the length of the door frame; attaching one part of second strip to an end surface of the door and one part of the second strip to the first strip; attached the at least two connecting members to one edge of the first strip; and attaching the third strip to and across the connection members.

### BRIEF DESCRIPTION OF THE DRAWINGS

FIG. 1 is a schematic illustration of a finger guard assembly constructed in accordance with the invention, when assembled and in use, the door being open;

FIG. 2 is a schematic illustration of a finger guard assembly of FIG. 1, the door being closed;

FIG. 3 is a cross-sectional view of a first strip constructed in accordance with the invention;

FIG. 4 is a schematic illustration showing the interaction of the strips of the assembly;

FIG. 5 shows the assembly partially installed;

FIG. 6 is a cross-sectional view of a second strip constructed in accordance with the invention; and

FIG. 7 is a cross-sectional view of a third strip constructed in accordance with the invention.

### DETAILED DESCRIPTION OF THE INVENTION

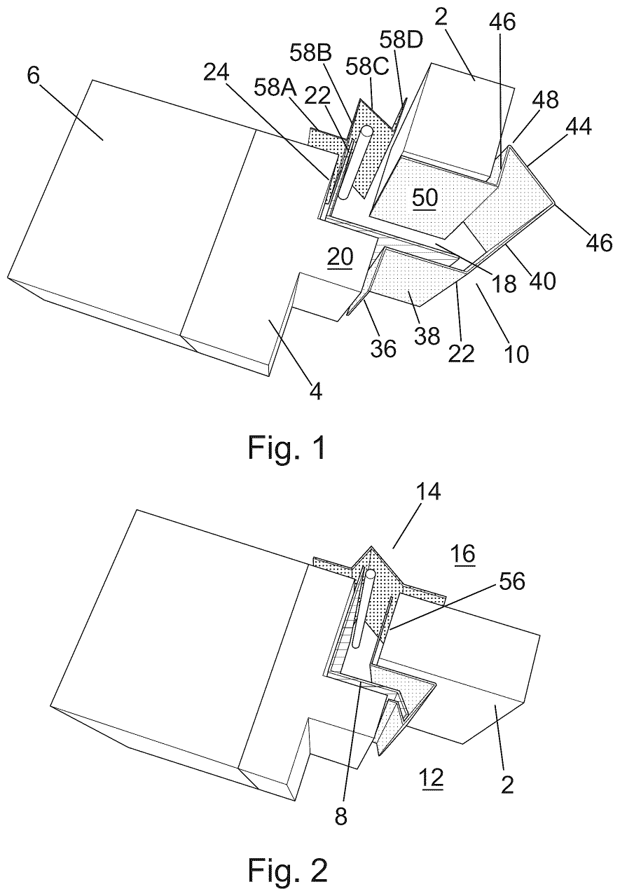

FIGS. 1 and 2 provide a schematic illustration of a finger guard assembly, assembled and in use. FIG. 1 illustrates when the door 2 is in an open position relative to the door frame 4 secured to a wall 6, and FIG. 2 illustrates when the door 2 is closed.

As can be seen, the assembly is constructed of three strip sections and connecting members. The strips of the assembly are designed and assembled in such a way that connection is only required to the inner door frame and end surface of the door.

Reference to “end surface” means the rear edge surface of the door proximal to and extending between the door hinges.

A first strip 8 is locatable in use within the door frame so extend generally perpendicularly between second and third strips 10, 12 and being connectable to the second and third strips 10, 12 at respective ends.

The second strip 10 is locatable, in use, on the inside 12 of the door 2. This strip 10 provides a finger guard extending lengthwise along the inside 12 of the door 2 to prevent a person catching their fingers between the door 2 and the door frame 4 when the door 2 is shut.

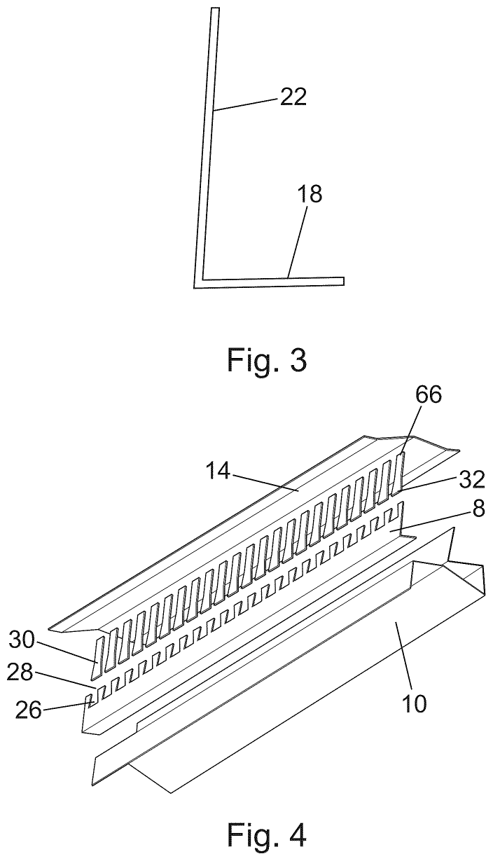

The third strip 14 is locatable, in use, on the outside 16 of the door 2. This strip 14 provides a finger guard extending lengthwise along the outside 16 of the door 2 when the door is closed. Reference to “inside” for the purpose of this description means the side of the doorway towards which the door moves when being closed. Similarly, reference to “outside” means the side of the doorway with the exposed hinges, to which the door moves away from, when being closed. The first strip 8 is the main supporting element of the assembly. A cross-section view of the first strip 8 is shown in FIG. 3. The strip 8 is preferably made from a flexible thermoplastic polymer such as ABS, for example.

The strip 8 has a generally L shaped profile. In use, as can be seen in FIGS. 1 and 2, a first arm 18 of the strip 8 is secured to the inner door frame, against the sidewall of the door stop 20 using a tack or non-permanent adhesive, by using self-adhesive tape, for example.

A second arm 22 of the strip 8 is also secured to the inner door frame, against the door jam 24 of the door frame 4, in use so to extend between and across the door hinges.

FIG. 4 is a schematic illustration which shows the first strip 8 (and other strips 10, 14) in perspective. It can be seen that the end of the arm 22 of the strip 8 is formed with an array of dovetail recesses 26.

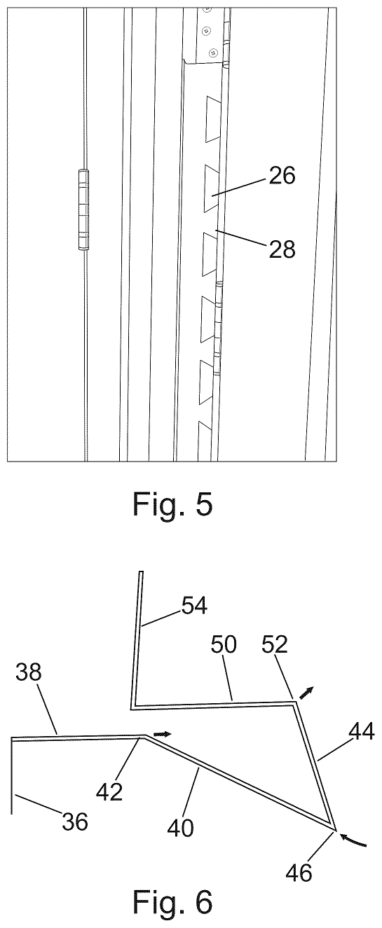

When secured in the door frame 4, the finger extensions 28 formed by the recesses 26 extend though the door hinges, as can be seen in FIG. 5.

The recesses 26 extending through the door frame provide accessible connection points for connecting members 30.

Each connecting member 30 has a complimentary shaped dovetail profile 32 at one end to be received into a respective recess 26 of the third strip 8.

In the embodiment described the connection mechanism of the connecting members 30 to the strip 8 uses dovetail joints. Any other suitable connection mechanism may be used. However, any overlap which would increase the thickness at the point of connection is to be avoided.

The plurality of recesses 26 formed along the length of the strip 8 allows the installer to select the number and locations of the connecting members 30 so that the hinges themselves, which block the path through the door frame at that point, are not obstructive to the overall connection mechanism.

A cross-section view of the second strip 10 is shown in FIG. 6. The strip 10 is made from the same semi-rigid flexible material as the first strip 8.

Other materials may be used provided they have semi-rigid but flexible characteristics so that they hold their shape when flexed about living hinges.

The strip 10 is folded into six sections along its length the connections of which provide flexible hinges so to form an effective dynamic finger guard along the length of the inside of the door in order to prevent a person from placing their fingers between the door 2 and the door frame 4 and trapping them when the door 2 is closed.

A first end section 36 of the strip 10 lies generally adjacent the end surface of the door stop 20, of the door frame 4, in use, without being secured to it The first end section 36 leads to a second section 38 extending generally perpendicular to the first end section 36. The second section 38 is connected to an end section of the first arm 18 of the first strip 8 using a tack or non-permanent adhesive, by using self-adhesive tape, for example. To this end, for example, the second section 38 may have an adhesive layer with a paper liner that is removed to expose the adhesive to stick it to the first strip 8.

The second section 38 leads to a third section 40 extending from the second section 18 at an obtuse angle through a first flexible hinge 42. The flexing direction of the hinge 42 is shown by an arrow in FIG. 6. The third section 40 leads to a fourth section 44 extending from the third section 40 at an acute angle through a second flexible hinge 46. The flexing direction of the hinge 46 is shown by an arrow in FIG. 3. The fourth section 44 leads to a fifth section 48 extending from the fourth section 44 at an angle towards the first end section 36 through a third flexible hinge 60. Finally, the fifth section 48 leads to a second end section 62 at an angle of approximately 85 degrees.

The second end section 62 is attached to the end surface 64 of the door 2 using a tack or non-permanent adhesive, by using self-adhesive tape for example.

By attaching to the end surface 64 of the door 2, any marks left on removal are not generally visible.

A cross-section view of the third strip 16 is shown in FIG. 4. The strip 16 is made from the same semi-rigid flexible material as the first and second strips 8, 12.

The strip 14 is formed in four sections 66 separated by three flexible hinges 68.

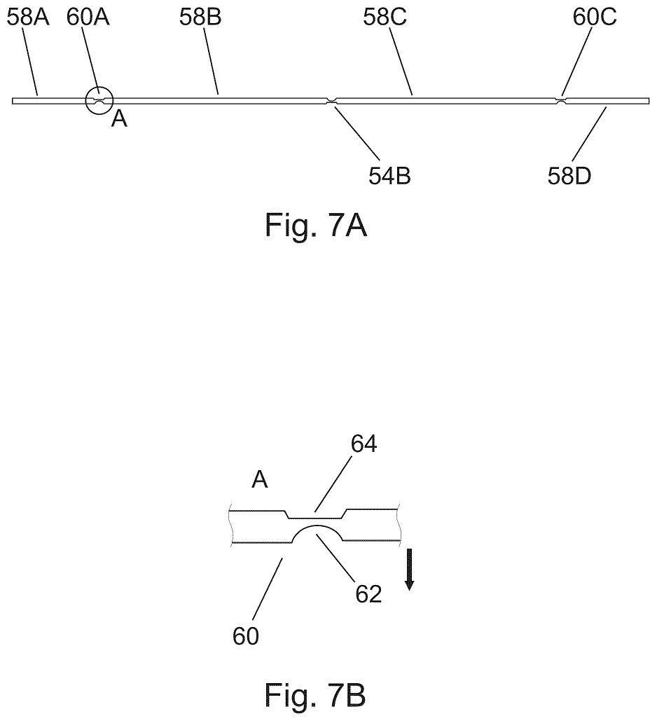

The hinge 68 can be seen in FIG. 7B. It is designed to flex in only one direction, so to retain the shape structure of the finger guard during flexing. The hinge 68 forms a section of reduced thickness to allow the flexing. One side 70 of the hinge 68 is arcuate and the opposing side 72 is straight. These features, combined with the semi-rigidity characteristics of the material cause the hinge 68 shown in FIG. 7B to flex in only the direction of the arrow.

Similar structures of hinge are used on the first and second strips 8, 12 where flexing should only be one direction to maintain the structure and shape of the strip as it flexes.

Once the first strip 8 is connected through and across the inner door frame 4, the ends 74 of the connecting members 30 distal to the dovetail joints 32 provide spaced parallel structures to secure the third strip 16 to the outside of the door 2.

As can be seen in FIGS. 1 and 2, the second section 66B of the first strip 8 is securable to each end 74 of the connecting members 30 using a tack or non-permanent adhesive, by using self-adhesive tape, for example.

When secured, the strip 16 provides a finger guard extending lengthwise along the outside 16 of the door 2 to prevent a person catching their fingers between the door 2 and the door frame 4 when the door 2 is shut.

Any number of connecting members 30 and recesses 26 may be provided, the limitation being the length of the strip 8. A minimum of two may be used. In such a case, one connecting member would need to be placed at or near the top and the other connecting member would need to be placed at or near the bottom of the door 2 to ensure that each finger guard is sufficiently secured at each end to provide an effective guard along the entire door length.

More than two connecting members 30 would however be preferable to ensure that each finger guard is effective across its entire length.

The flexible hinges of the first and second strips 8, 12 allow the strips 8, 12 to flex and fold as the door 2 moves between an open and closed position whilst maintaining the structure and integrity of each finger guard along the length of each side of the door 2.

The finger guards provided by the first and second strips 8, 12, either side of the door frame provide protection for doors opening between 90 and 180 degrees.

When no longer required, the assembly can be simply dis-assembled by detaching the third strip 14 from the connection members 30, detaching the first strip 8 inside door frame, and detaching the second strip 10 from the end surface 36 of the door 2.

1-18. (canceled)

19. A finger guard assembly for a door hingedly attached to a door frame, the assembly comprising:
a first strip having attachment means configured to allow attachment the strip along at least part of the length of the door frame and having a first longitudinal edge formed with at least two shaped recesses, and
a second strip having attachment means configured to allow attachment one side of the door frame to a second longitudinal edge of the first strip, distal to the first longitudinal edge; and
a third strip having attachment means to allow attachment to the connecting members on the other side of the door frame.

20. A finger guard assembly according to claim 19, wherein at least one strip is made from a thermoplastic polymer material.

21. A finger guard assembly according to claim 19, wherein the first strip has a substantially L-shaped profile.

22. A finger guard assembly according to claim 21, wherein one arm of the first strip is attachable to a sidewall of a door stop of the door frame, in use.

23. A finger guard assembly according to claim 21, wherein the arm is attached using self-adhesive tape.

24. A finger guard assembly according to claim 22, wherein a second arm of the L-shaped profile of the first strip is attached to a door jam of the door frame, in use.

25. A finger guard assembly according to claim 24, wherein the second arm is attached using self-adhesive tape.

26. A finger guard assembly according to claim 24, wherein a longitudinal edge of the second arm is formed with a plurality of dovetail recesses.

27. A finger guard assembly according to claim 19, wherein the second strip comprises a plurality of sections divided by flexible hinges.

28. A finger guard assembly according to claim 19, wherein one section of the second strip is attachable in use, to the first strip.

29. A finger guard assembly according to claim 19, wherein an end section of the second strip is attachable to an end surface of the door, in use.

30. A finger guard assembly according to claim 19, wherein the third strip comprises a plurality of sections divided by flexible hinges.
